(19) United States
(12) Patent Application Publication
(10) Pub. No.: US 2025/0377580 A1
(43) Pub. Date: Dec. 11, 2025

(54) REFLECTIVE MODULE AND CAMERA MODULE INCLUDING THE SAME

(71) Applicant: Samsung Electro-Mechanics Co., Ltd., Suwon-si (KR)

(72) Inventors: Young Hwan KWON, Suwon-si (KR); Min Jeong KANG, Suwon-si (KR); Do Seop HWANG, Suwon-si (KR); Po Chul KIM, Suwon-si (KR)

(73) Assignee: Samsung Electro-Mechanics Co., Ltd., Suwon-si (KR)

(21) Appl. No.: 19/228,099

(22) Filed: Jun. 4, 2025

(30) Foreign Application Priority Data
Jun. 5, 2024 (KR) 10-2024-0073891
Oct. 11, 2024 (KR) 10-2024-0138443
May 9, 2025 (KR) 10-2025-0060356

(51) Int. Cl. G03B 17/10; G02B 7/18; G02B 7/182; G03B 5/00; G03B 17/12; G03B 17/17; G03B 30/00

(52) U.S. Cl. CPC G03B 17/10; G02B 7/1805; G02B 7/1821; G03B 5/00; G03B 17/12; G03B 17/17; G03B 30/00; G03B 2205/0023; G03B 2205/003

(57) ABSTRACT

A reflective module includes a housing having an internal space, a rotation guide disposed in the internal space and configured to rotate about a first axis, relative to the housing, a reflective member holder including a reflective member and supported by the rotation guide, and a damper protruding from a bottom surface of the housing toward the internal space, wherein the damper includes a first damper disposed adjacently to the first axis, and a second damper disposed in a position spaced apart from the first damper.

### CROSS-REFERENCE TO RELATED APPLICATIONS

This application claims the benefit under 35 USC 119 (a) of Korean Patent Application Nos. 10-2024-0073891 filed on Jun. 5, 2024, 10-2024-0138443 filed on Oct. 11, 2024, and 10-2025-0060356 filed on May 9, 2025, in the Korean Intellectual Property Office, the entire disclosures of which are incorporated herein by reference for all purposes.

### BACKGROUND

### 1. Field

The following disclosure relates to a reflective module and a camera module including the reflective module.

### 2. Description of the Background

Camera modules implemented in mobile devices have been manufactured to have performance comparable to that of typical cameras.

For example, a camera module implemented in a mobile device may include a reflective member. Since the reflective member bends a path of light, the light path may be sufficiently increased without increasing the thickness of the mobile device, thereby improving the performance of the camera module.

The reflective member may be provided to be rotatable when optical image stabilization (OIS) is performed on the camera module. For example, rotation of the reflective member may be supported by ball bearings. The ball bearing basically acts like a wheel and may help movement of the reflective member with a relatively small force, but depending on the position in which the ball bearings are positioned, the ball bearing may hinder driving.

Meanwhile, the components constituting the camera module may cause noise while moving due to internal and external factors.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a reflective module includes a housing having an internal space, a rotation guide disposed in the internal space and configured to rotate about a first axis, relative to the housing, a reflective member holder including a reflective member and supported by the rotation guide, and a damper protruding from a bottom surface of the housing toward the internal space, wherein the damper includes a first damper disposed adjacently to the first axis, and a second damper disposed in a position spaced apart from the first damper.

The reflective module may further include a pivot ball disposed between the housing and the rotation guide, through which the first axis passes, and a plurality of guide balls disposed in a position spaced apart from the pivot ball between the housing and the rotation guide. A distance between the pivot ball and the first damper may be shorter than a distance between the pivot ball and the plurality of guide balls, and a distance between the pivot ball and the second damper may be greater than the distance between the pivot ball and the plurality of guide balls.

The rotation guide may include a damper accommodating portion penetrating through the rotation guide in a direction parallel to the first axis, and the first damper may be disposed in the damper accommodating portion.

The damper accommodating portion may have a width increasing away from the first axis at least in a portion.

The damper accommodating portion may include a first side surface facing the first damper in a first direction, and a second side surface facing the first damper in a second direction perpendicular to the first direction, wherein the first direction and the second direction are directions perpendicular to the first axis.

The first side surface may include a step portion formed to protrude toward the first damper, and the damper accommodating portion may have a width that is narrowed once in the step portion.

When the rotation guide rotates based on the first axis, the first damper may contact the first side surface on the outside of the step portion in a radial direction of a circle centered on the first axis.

The first damper may face the reflective member holder in the first-axis direction.

The rotation guide may protrude toward the housing and include a first protrusion facing the second damper in a radial direction of a circle centered on the first axis.

Opposing surfaces of the second damper and the first protrusion may be curved.

The opposing surfaces of the second damper and the first protrusion may each include a portion of a circle having an arbitrary radius centered on the first axis.

The first damper and the second damper may each include a plurality of dampers spaced apart from each other in a direction perpendicular to the first axis.

The reflective module may further include an auxiliary damper disposed between the second dampers and facing the rotation guide, wherein the rotation guide may include a second protrusion facing the auxiliary damper in a radial direction of a circle centered on the first axis.

Opposing surfaces of the auxiliary damper and the second protrusion may be curved.

A camera module may include the reflective module, and a lens module including a plurality of lenses disposed in an optical axis direction and configured to be movable in the optical axis direction.

The reflective module may be configured to be rotatable about the first axis and a second axis perpendicular to the first axis, and both the first axis and the second axis may be perpendicular to the optical axis direction.

Other features and aspects will be apparent from the following detailed description, the drawings, and the claims.

### BRIEF DESCRIPTION OF DRAWINGS

FIG. 1 is a perspective view of an example camera module, in accordance with one or more embodiments.

FIG. 2 is an internal perspective view of a camera module according to an embodiment of the present disclosure.

FIG. 3 is a schematic exploded perspective view of an example camera module, in accordance with one or more embodiments.

FIG. 4A is a cross-sectional view taken along line I-I′ of FIG. 1.

FIG. 4B is a cross-sectional view taken along line II-II′ of FIG. 1.

FIG. 5 is a full exploded perspective view of a camera module according to an embodiment of the present disclosure.

FIG. 6 is a perspective view of a housing according to an embodiment of the present disclosure.

FIG. 7 is a perspective view of a main substrate according to an embodiment of the present disclosure.

FIG. 8 is a perspective view illustrating a main substrate coupled to a housing according to an embodiment of the present disclosure.

FIG. 9 is a perspective view of a reflective module according to an embodiment of the present disclosure.

FIG. 10A is an exploded perspective view of a reflective module according to an embodiment of the present disclosure.

FIG. 10B is a bottom exploded perspective view of a reflective module according to an embodiment of the present disclosure.

FIG. 11 is a cross-sectional view taken along line III-III′ of FIG. 9.

FIG. 12 is a bottom perspective view of a reflective module according to an embodiment of the present disclosure.

FIG. 13 illustrates the arrangement of a second ball member supporting rotation of the rotation guide.

FIG. 14 is a plan view illustrating the appearance of the rotation guide arranged in the housing.

FIG. 15 is an enlarged view of region A (a first damper) of FIG. 14.

FIG. 16 is an enlarged view of region B (a second damper) of FIG. 14.

FIGS. 17A and 17B are diagrams illustrating a rotation state of the rotation guide.

FIG. 18 is a diagram illustrating a configuration in which an auxiliary damper is additionally disposed.

FIG. 19 is a cross-sectional view taken along line IV-IV′ of FIG. 9.

FIG. 20 is an exploded perspective view of a lens module according to an embodiment of the present disclosure.

FIG. 21 is a bottom exploded perspective view of a lens module according to an embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences within and/or of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The one or more examples relate to a reflective module and a camera module including the same and may be applied to mobile devices. For example, mobile devices may be a portable electronic device, such as smartphones, tablet personal computers (PCs), etc.

The present disclosure aims to solve the aforementioned problems in a camera module having a reflective member. Specifically, the present disclosure aims to provide a reflective module with improved driving stability and noise and a camera module including the same.

According to embodiments of the present disclosure, the driving stability of the reflective module and the shake correction performance (or optical image stabilization) of the camera module may be improved.

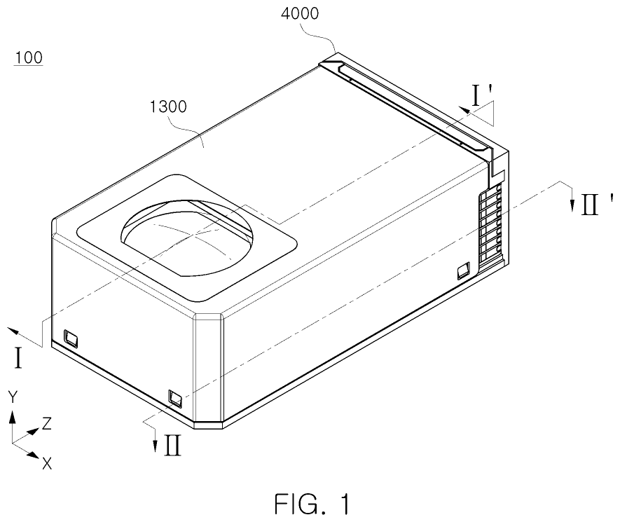

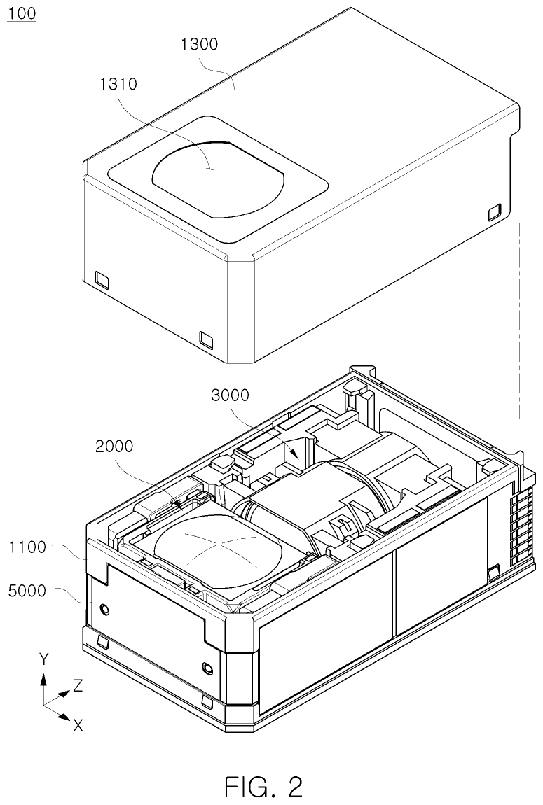

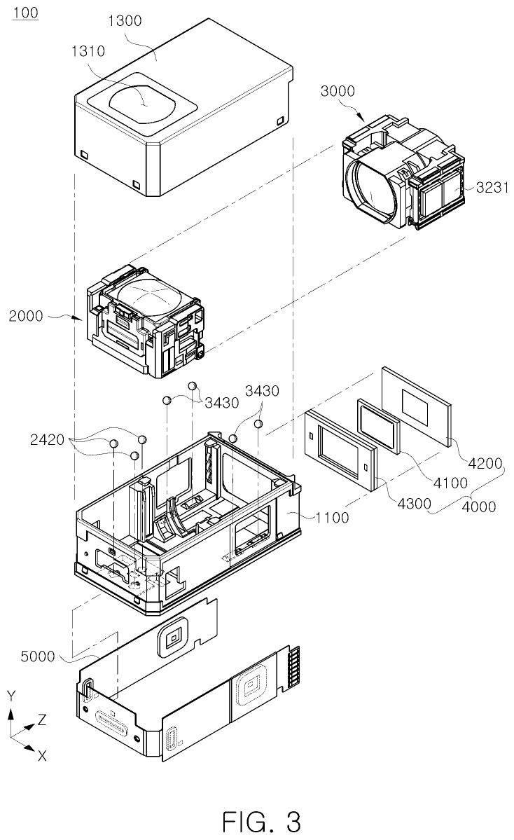

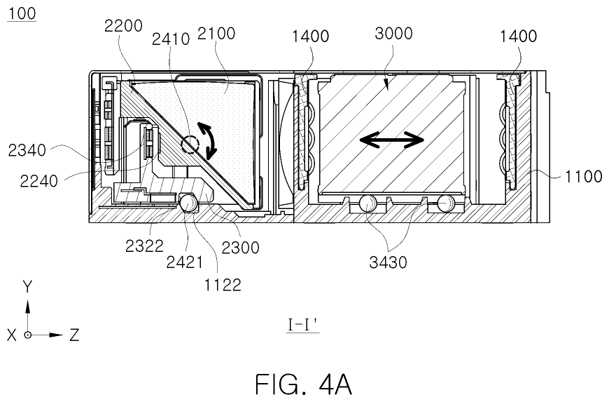

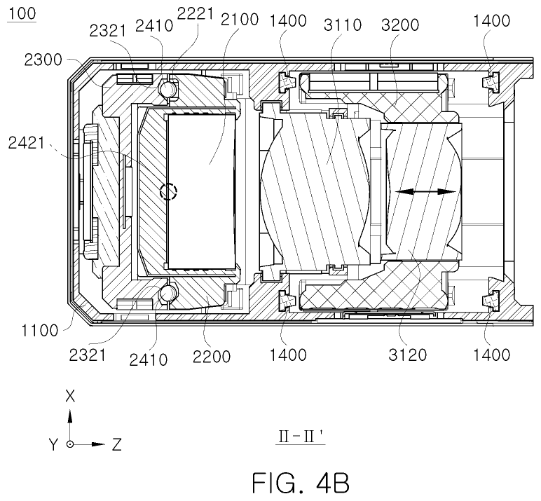

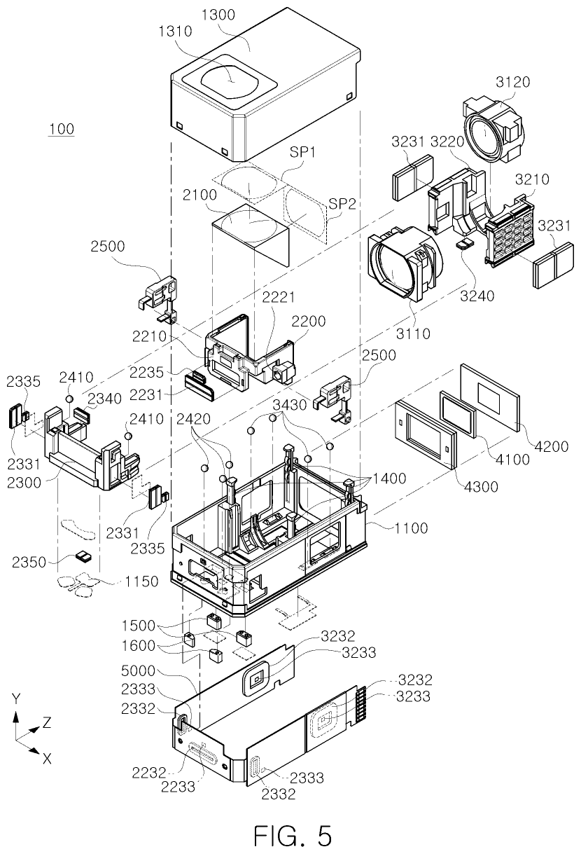

FIG. 1 is a perspective view of an example camera module, in accordance with one or more embodiments, FIG. 2 is an internal perspective view of an example camera module, in accordance with one or more embodiments, FIG. 3 is a schematic exploded perspective view of an example camera module, in accordance with one or more embodiments, FIG. 4A is a cross-sectional view taken along line I-I′ of FIG. 1, FIG. 4B is a cross-sectional view taken along line II-II′ of FIG. 1, and FIG. 5 is a full exploded perspective view of an example camera module, in accordance with one or more embodiments.

A camera module 100, in accordance with one or more embodiments, may include a reflective module 2000, a lens module 3000, and an image sensor module 4000.

The reflective module 2000, the lens module 3000, and the image sensor module 4000 are arranged in a housing 1100, and a case 1300 is coupled to the housing 1100 to cover a portion of the housing 1100.

Light incident on the camera module 100 may be changed a traveling direction in a reflective module 2000. The reflective module 2000 includes a reflective member 2100 reflecting light so that a path of light is changed.

Referring to FIG. 2 and FIG. 4A, the reflective member 2100 may configured to change the light incident in a thickness direction (a Y-axis direction) of the camera module 100 to a length direction (a Z-axis direction) of the camera module 100.

The lens module 3000 may include a plurality of lenses that refract the light. The plurality of lenses may be provided in the length direction (the Z-axis direction) of the camera module 100. That is, an optical axis (Z-axis) is formed to be parallel to the length direction (the Z-axis direction) of the camera module 100.

Referring to FIG. 3, the image sensor module 4000 may include an image sensor 4100 and a printed circuit board 4200 on which the image sensor 4100 is mounted.

The light incident on the camera module 100 may be incident on the image sensor 4100 passing through the lens module 3000, and subsequently converted into a corresponding electrical signal in the image sensor 4100.

One or more baffles (not shown) may be provided between the lens module 3000 and the image sensor 4100 to reduce a flare phenomenon. The baffles may be arranged in an internal space of the housing 1100 described below.

In addition, the image sensor module 4000 may further include an optical filter 4300 that is disposed between the lens module 3000 and the image sensor 4100 and filters light in a specific wavelength range. In an example, the optical filter 4300 may be an infrared cut filter that filters light in an infrared wavelength range.

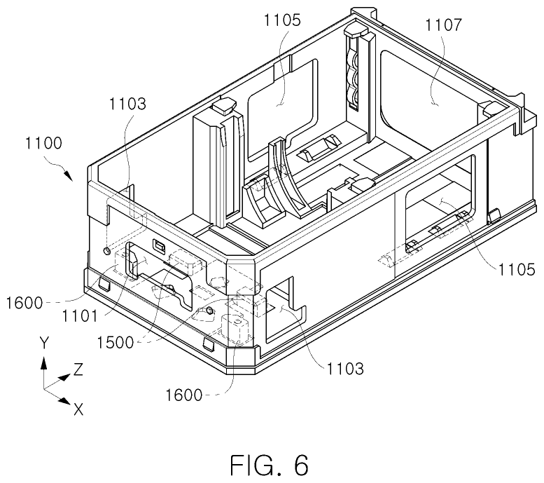

FIG. 6 is a perspective view of the housing, in accordance with one or more embodiments.

Referring to FIG. 6, the housing 1100 has a rectangular box shape with an open top and an internal space. As mentioned above, the reflective module 2000, the lens module 3000 and the image sensor module 4000 may be sequentially arranged in the traveling direction of incident light.

For example, the reflective module 2000 and the lens module 3000 may be accommodated in the internal space of the housing 1100, and the image sensor module 4000 may be disposed on an outer surface of the housing 1100 so that an imaging plane of the image sensor 4100 is towards the internal space.

The structure in which the optical modules constituting the camera module 100 are arranged together in one housing 1100 has the advantages of facilitating assembly and facilitating alignment of the optical axis (Z axis).

Meanwhile, the reflective module 2000, the lens module 3000 and the image sensor module 4000 may each be accommodated in a housing, respectively, and the housings may also be connected to each other.

The reflective module 2000 and the lens module 3000 are provided to be movable in the housing 1100. For example, in the internal space of the housing 1100, the lens module 3000 moves in an optical axis direction (the Z-axis direction), and the reflective module 2000 rotates with two axes (the X-axis and Y-axis), perpendicular to the optical axis (Z-axis), as a rotation axis.

The camera module 100 includes a driving unit providing driving force to move the reflective module 2000 and the lens module 3000.

The driving unit includes a magnet and a coil, and the coil may be mounted and provided on a printed circuit board (hereinafter, a main board) 5000.

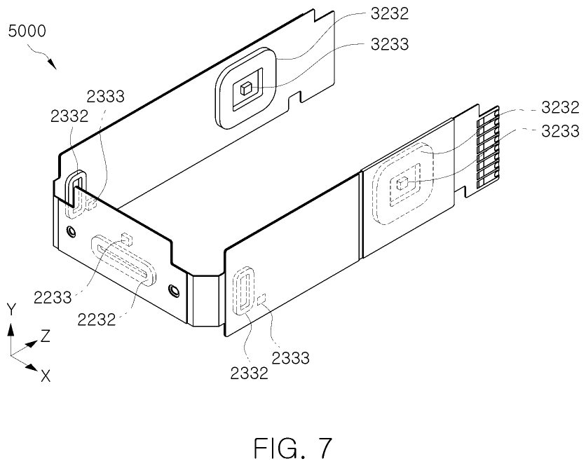

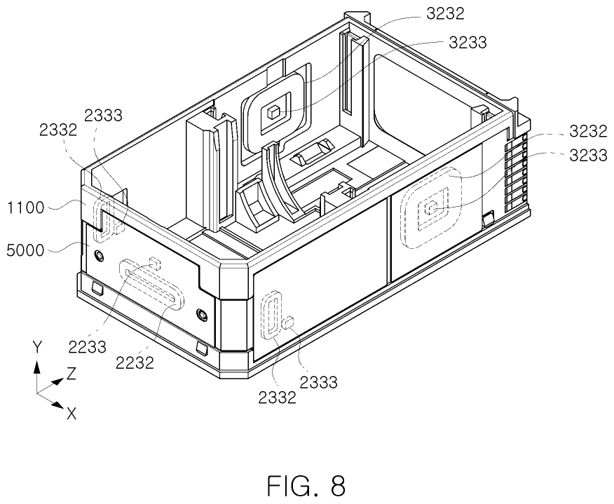

FIG. 7 is a perspective view of the main substrate, in accordance with one or more embodiments, and FIG. 8 is a perspective view illustrating the main substrate coupled to the housing, in accordance with one or more embodiments.

According to an embodiment, the main substrate 5000 may be arranged on multiple surfaces of the housing 1100. Referring to FIG. 8, the main substrate 5000 may be disposed to cover side surfaces of the housing 1100.

The housing 1100 may include through-holes 1101, 1103, 1105, and 1107, and the driving coils mounted on the main substrate 5000 may be exposed to the internal space through the through-holes 1101, 1103, and 1105. In addition, the imaging plane of the image sensor 4100 may also be exposed to the internal space through the through-hole 1107.

The case 1300 may be coupled to the housing 1100 to cover the open upper portion of the housing 1100. In an embodiment, the case 1300 may include a metal material to function as a shield can.

The case 1300 may have a function of protecting the components disposed in the internal space of the housing 1100. In addition, the case 1300 is formed of a material including metal and serves to shield electromagnetic waves.

The case 1300 may include an opening 1310.

The reflective module 2000 may be disposed to overlap the opening 1310, and exposed to an outside through the opening 1310. Therefore, light may be incident on the reflective module 2000 through the opening 1310.

The camera module 100, in accordance with one or more embodiments, may have an optical image stabilization (OIS) operation and an autofocusing (AF) operation.

In an embodiment, the reflective module 2000 may be provided to be rotatable when compensating for a shake, and the lens module 3000 may be provided to be movable when adjusting the focus. Both movement of the reflective module 2000 and the lens module 3000 may be a relative movement with respect to the housing 1100.

The camera module 100, in accordance with one or more embodiments, may also have a zoom operation. For the zoom operation, the lens module 3000 may include a plurality of lens barrels on which one or more lenses are mounted.

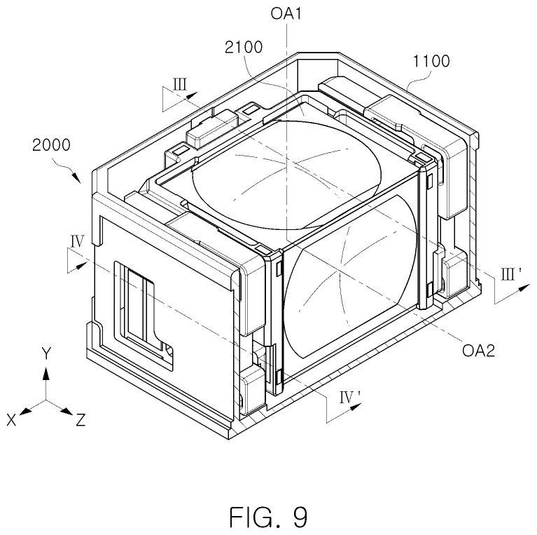

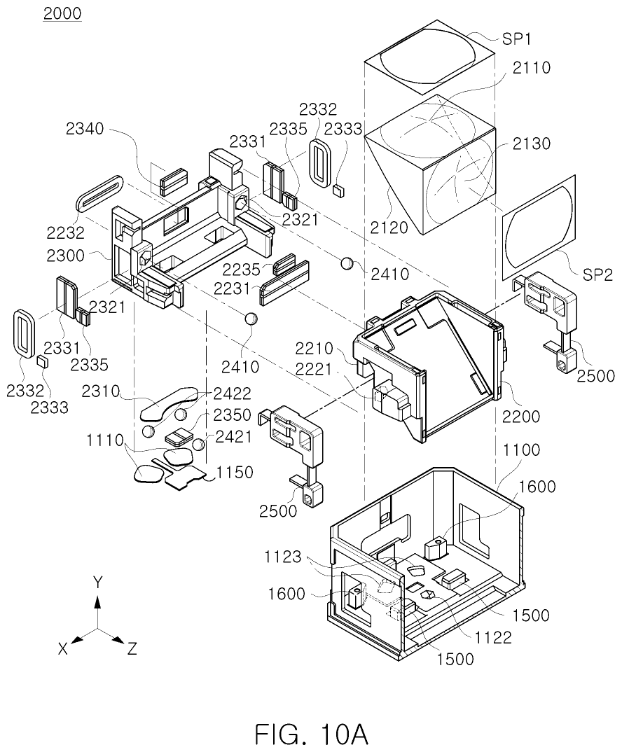

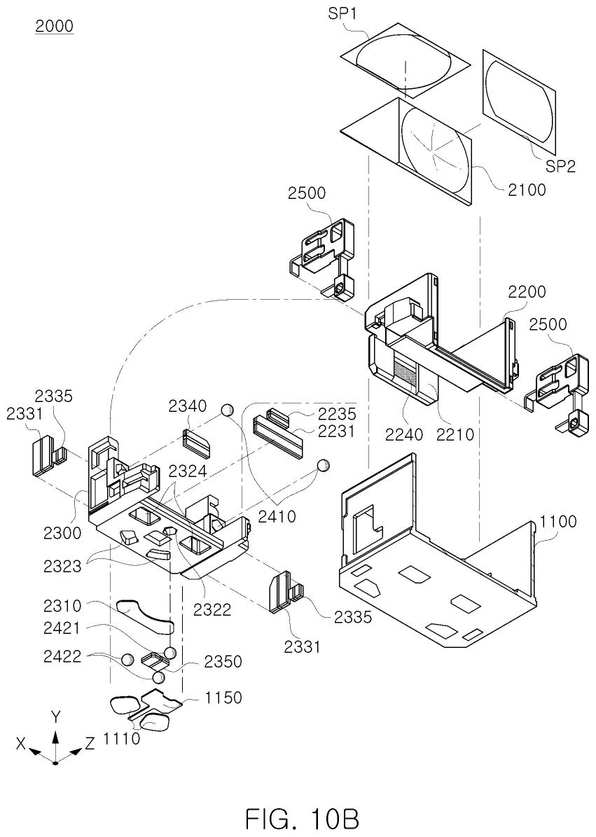

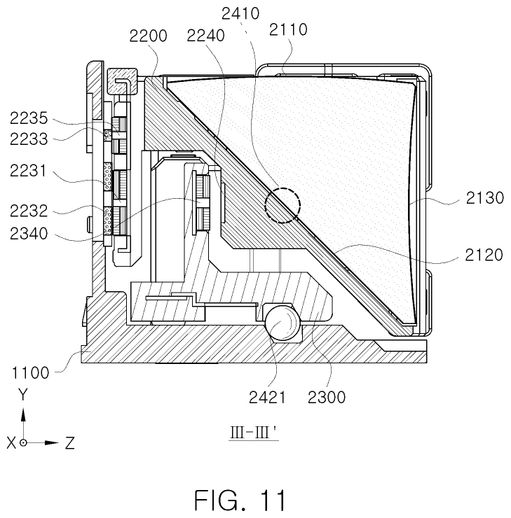

FIG. 9 is a perspective view of a reflective module according to an embodiment of the present disclosure, FIG. 10A is an exploded perspective view of a reflective module according to an embodiment of the present disclosure, FIG. 10B is a bottom exploded perspective view of a reflective module according to an embodiment of the present disclosure, and FIG. 11 is a cross-sectional view taken along line III-III′ of FIG. 9.

According to an embodiment, the reflective module 2000 may include a reflective member holder 2200 on which the reflective member 2100 is disposed and a rotation guide 2300 on which the reflective member holder 2200 is supported.

The reflective member holder 2200 may be rotatably supported by the rotation guide 2300, and the rotation guide 2300 may be rotatably supported by the housing 1100.

According to an embodiment, the reflective member 2100 may be provided as a prism including an incident surface 2110, a reflective surface 2120, and an exit surface 2130. However, this is only an example, and, in another example, the reflective member 2100 may be provided as a mirror.

When a direction in which the light is incident is defined as a first optical axis OA1 direction, the first optical axis OA1 may pass through the center of the incident surface 2110. In addition, when the optical axis direction (the Z-axis direction) formed by the lens module 3000 is defined as a second optical axis OA2 direction, the second optical axis OA2 may pass through the center of the exit surface 2130.

The reflective surface 2120 may be disposed obliquely with respect to the incident surface 2110 and the exit surface 2130. In an example, the first optical axis OA1 and the second optical axis OA2 may intersect at approximately the center of the reflective surface 2120. The reflective surface 2120 may change the traveling direction of light incident in the first optical axis OA1 direction to the second optical axis OA2 direction.

According to an embodiment, the incident surface 2110 and the exit surface 2130 of the reflective member 2100 may have curvatures. For example, referring to FIG. 11, the incident surface 2110 of the reflective member 2100 may have a convex shape toward an object side, and the exit surface 2130 of the reflective member 2100 may have a concave shape toward an image side. The incident surface 2110 and the exit surface 2130 may have different shapes than those presented.

Since the incident surface 2110 and the exit surface 2130 may have curvatures, the reflective member 2100 may operate as a lens.

Spacers SP1 and SP2 may be provided on an object side of the incident surface 2110 and an image side of the exit surface 2130, respectively.

The spacers SP1 and SP2 may include an opening through which the light passes, and a light blocking portion black-coated along the periphery of the opening. The light blocking portion may block light passing through the corresponding region by covering the periphery of an effective region of the incident surface 2110 and the exit surface 2130.

According to an embodiment, the reflective module 2000 may be provided to be rotatable about two axes (the X-axis and the Y-axis) perpendicular to the optical axis (the Z-axis).

In an embodiment, the reflective member holder 2200 may be rotated about a first axis (the X-axis) while being supported by the rotation guide 2300, and the rotation guide 2300 may be rotated about a second axis (the Y-axis) together with the reflective member holder 2200, while being supported by the housing 1100.

Two rotation axes (the X-axis and the Y-axis) may be perpendicular to each other.

A first ball member 2410 may be disposed between the reflective member holder 2200 and the rotation guide 2300.

The first ball member 2410 may separate the reflective member holder 2200 and the rotation guide 2300, and support the rotation of the reflective member holder 2200 relative to the rotation guide 2300.

In an embodiment, the first ball member 2410 may include a plurality of balls, for example, two balls, that are spaced apart from each other in the first-axis direction (the X-axis direction) with the reflective member 2100 interposed therebetween.

The first ball member 2410 may form a first axis (the X-axis). For example, a virtual line connecting the two balls may be the first axis (the X-axis).

The first ball member 2410 may rotate while being fixed in position with respect to the reflective member holder 2200 and the rotation guide 2300.

Accommodating recesses may be provided in the reflective member holder 2200 and the rotation guide 2300 accommodating the first ball member 2410.

The reflective member holder 2200 may be provided with first accommodating recess 2221 spaced apart in the first-axis direction (the X-axis direction), and the rotation guide 2300 may be provided with second accommodating recess 2321 in positions facing the first accommodating recess 2221. The first accommodating recess 2221 and the second accommodating recess 2321 may face each other in the optical axis direction (the Z-axis direction).

The first ball member 2410 may be accommodated between the first accommodating recess 2221 and the second accommodating recess 2321, respectively.

A portion of the first ball member 2410 may be accommodated in the first accommodating recess 2221, and another portion of the first ball member 2410 may be accommodated in the second accommodating recess 2321.

The first ball member 2410 may be supported at three or two points by the first accommodating recess 2221 and the second accommodating recess 2321.

In an embodiment, the first accommodating recess 2221 and the second accommodating recess may include three inclined surfaces so that the first ball member 2410 may rotation in place. Also, the first accommodating recess 2221 or the second accommodating recess may include two inclined surfaces to overcome defects due to tolerance.

The reflective member holder 2200 may be closely supported on the rotation guide 2300 by a magnetic force (magnetic attraction).

The reflective module 2000 may include a pair of magnetic members that are disposed in the reflective member holder 2200 and the rotation guide 2300. Referring to FIG. 11, the pair of magnetic members may include a pulling magnet 2340 disposed in the rotation guide 2300 and a pulling yoke 2240 disposed in the reflective member holder 2200. The pulling yoke 2240 may be inserted into the reflective member holder 2200 and provided integrally with the reflective member holder.

The pulling magnet 2340 and the pulling yoke 2240 may be disposed to face each other, and generate a magnetic attraction in a direction in which they face each other. The pulling magnet 2340 and the pulling yoke 2240 may face in the optical axis direction (the Z-axis direction), and generate the magnetic attraction in the optical axis direction (the Z-axis direction). By the magnetic attraction, the reflective member holder 2200 may be closely supported on the rotation guide 2300 in the optical axis direction (the Z-axis direction).

In an example, the direction in which the reflective member holder 2200 is supported by the rotation guide 2300 may match the direction in which the reflective member holder 2200 and the rotation guide 2300 face each other with the first ball member 2410 interposed therebetween. Therefore, by the magnetic attraction, the first ball member 2410 may not escape from between the reflective member holder 2200 and the rotation guide 2300.

The reflective module 2000 may include a first driving unit that provides a driving force to rotate the reflective member holder 2200.

The first driving unit may include a first driving magnet 2231 and a first driving coil 2232 arranged to face each other.

The first driving magnet 2231 may be disposed in the reflective member holder 2200, and the first driving coil 2232 may be disposed in the housing 1100.

In an embodiment, the reflective member holder 2200 may include an extension 2210 extending to the rear of the reflective member 2100 and disposed between the rotation guide 2300 and the housing 1100, and the first driving magnet 2231 may be disposed on the extension 2210. The first driving coil 2232 may be disposed on one surface of the housing 1100 facing the extension 2210. The first driving magnet 2231 may be in a one-to-one correspondence with the first driving coil 2232. In another embodiment, the positions of the first driving magnet 2231 and the first driving coil 2232 may be interchanged.

The first driving coil 2232 may be mounted on the main substrate 5000, and may be disposed in the housing 1100. The first driving coil 2232 may be exposed to the internal space of the housing 1100 through the through-hole 1101, and thus may directly face the first driving magnet 2231.

In an embodiment, the first driving magnet 2231 and the first driving coil 2232 may face each other in the optical axis direction (the Z-axis direction), and generate a driving force in a direction perpendicular to the optical axis (the Z-axis), for example, the second-axis direction (the Y-axis direction) in a position spaced apart from the first axis (the X-axis) (or the first ball member 2410). By the driving force, the reflective member holder 2200 may be rotated about the first axis (the X-axis).

A surface of the first driving magnet 2231, for example, a surface facing the first driving coil 2232 may include an N-pole and an S-pole. In an example, the surface of the first driving magnet 2231 may include an N-pole (S-pole) region, a neutral region, and an S-pole (N-pole) region in the second-axis direction (the Y-axis direction).

The reflective module 2000 may include a first position sensing unit (or sensor) that detects the position of the reflective member holder 2200.

The first position sensing unit may include a first sensing magnet 2235 and a first position sensor 2233 arranged to face each other.

The first sensing magnet 2235 may be disposed in the reflective member holder 2200, and the first position sensor 2233 may disposed in the housing 1100.

In an example, the first sensing magnet 2235 may be disposed in the extension 2210 of the reflective member holder 2200 together with the first driving magnet 2231. The first sensing magnet 2235 may be spaced apart from the first driving magnet 2231 in the second-axis direction (the Y-axis direction).

A surface of the first sensing magnet 2235 facing the first position sensor 2233 may include an S-pole (N-pole) region, a neutral region, and an N-pole (S-pole) region in the second-axis direction (the Y-axis direction). In an example, the first sensing magnet 2235 and the first driving magnet 2231 may be arranged adjacent to each other in the same polarity region (N-pole and N-pole or S-pole and S-pole).

The first position sensor 2233 may be mounted on the main substrate 5000 together with the first driving coil 2232 and be disposed in the housing 1100.

The first position sensor 2233 may be disposed to face the neutral region of the first sensing magnet 2235.

The first driving magnet 2231 and the first sensing magnet 2235 may be disposed in the reflective member holder 2200 and be rotated together with the reflective member holder 2200. On the other hand, the first driving coil 2232 and the first position sensor 2233 may be disposed fixedly in the housing 1100.

The first position sensor 2233 may detect a change in magnetic flux to detect the amount of movement of the reflective member holder 2200. In an example, the first position sensor 2233 may be provided as a Hall sensor.

The first position sensor 2233 may be spaced apart from the first driving coil 2232 in the second-axis direction (the Y-axis direction). The first position sensor 2233 may be less affected by the magnetic field of the first driving coil 2232, and thus, the sensing accuracy may be improved.

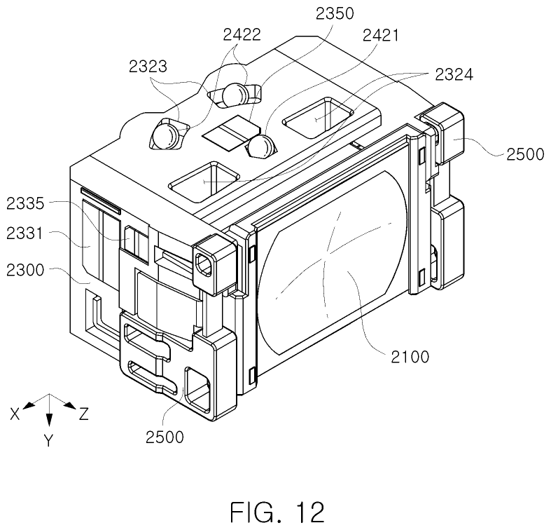

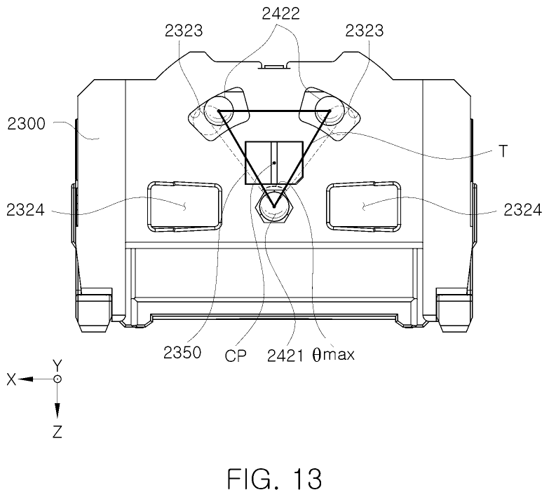

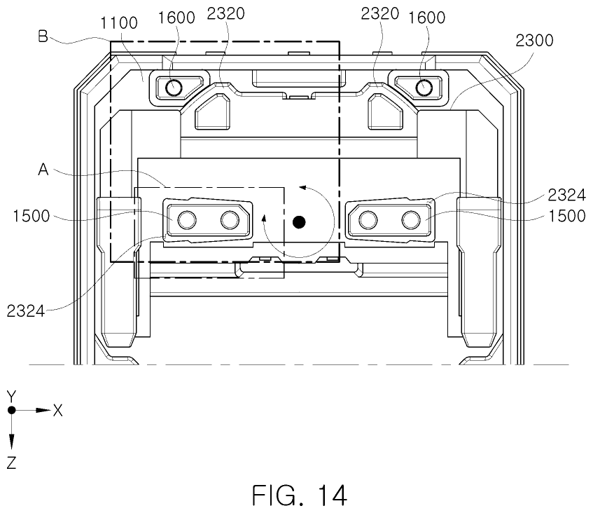

FIG. 12 is a bottom perspective view of a reflective module according to an embodiment of the present disclosure, FIG. 13 is a diagram illustrating the arrangement of a second ball member supporting rotation of the rotation guide, and FIG. 14 is a plan view illustrating the rotation guide disposed in the housing.

A second ball member 2420 may be disposed between the rotation guide 2300 and the housing 1100.

The second ball member 2420 may separate the rotation guide 2300 and the housing 1100, and support the rotation of the rotation guide 2300 with respect to the housing 1100.

In an embodiment, the second ball member 2420 may include a single pivot ball 2421 and a plurality of guide balls 2422, for example, two guide balls, spaced apart from the pivot ball 2421.

The pivot ball 2421 may form the second axis (the Y-axis). In an example, the second axis (the Y-axis) may pass through the pivot ball 2421.

The pivot ball 2421 may rotate while being fixed in position with respect to the rotation guide 2300 and the housing 1100.

Accommodating recesses may be provided in the rotation guide 2300 and the housing 1100 accommodating the second ball member 2420.

The rotation guide 2300 may be provided with third accommodating recess 2322 in a bottom surface, and the housing 1100 may be provided with fourth accommodating recess 1122 in a bottom surface. The third accommodating recess 2322 and the fourth accommodating recess 1122 may face each other in the second-axis direction (the Y-axis direction).

A portion of the pivot ball 2421 may be accommodated in the third accommodating recess 2322, and another portion of the pivot ball 2421 may be accommodated in the fourth accommodating recess 1122.

The pivot ball 2421 may be supported at three points in the third accommodating recess 2322 and the fourth accommodating recess 1122. The third accommodating recess 2322 and the fourth accommodating recess 1122 may include three inclined surfaces so that the pivot ball 2421 may rotate in place.

The plurality of guide balls 2422 may support the rotation of the rotation guide 2300 with respect to the second axis (the Y-axis) while rolling in a direction in which the rotation guide 2300 rotates.

The rotation guide 2300 and the housing 1100 may include guide rails that accommodate the plurality of guide balls 2422.

On the bottom surface of the rotation guide 2300, a first guide rail 2323 having a length approximately in the rotation direction of the rotation guide 2300 is provided and spaced apart in the first-axis direction (the X-axis direction). On the bottom surface of the housing 1100, a second guide rail 1123 having a length approximately in the rotation direction of the rotation guide 2300 is provided in a position facing the first guide rail 2323.

For example, the first guide rail 2323 and the second guide rail 1123 may have a curved shape, which may correspond to a portion of a circle centered on the rotation direction of the rotation guide 2300, i.e., the second axis (the Y-axis). Alternatively, the first guide rail 2323 and the second guide rail 1123 may have a straight shape, which may correspond to a tangent line that touches a circle centered on the second axis (the Y-axis).

The plurality of guide balls 2422 may be accommodated between the first guide rail 2323 and the second guide rail 1123, respectively.

A portion of the plurality of guide balls 2422 may be accommodated in the first guide rail 2323, and another portion of the plurality of guide balls 2422 may be accommodated in the second guide rail 1123.

The first guide rail 2323 and the second guide rail 1123 may have a width greater than the diameter of the plurality of guide balls 2422, and have a flat bottom surface.

The plurality of guide balls 2422 may contact on the bottom surface of the first guide rail 2323 and the second guide rail 1123. That is, the plurality of guide balls 2422 may be supported at one point on each of the first guide rail 2323 and the second guide rail 1123, and roll along a longitudinal direction of the first guide rail 232 and the second guide rail 1123. In this example, since the plurality of guide balls 2422 do not restrain the side surfaces defining the width of the first guide rail 2323 and the second guide rail 1123, they may roll relatively freely. However, as the positions of the plurality of guide balls 2422 change due to the rotation of the rotation guide 2300, the plurality of guide balls 2422 may be supported at two points on the first guide rail 2323 and/or the second guide rail 1123.

The rotation guide 2300 and the housing 1100 may further include support frames 2310 and 1110 inserted in positions corresponding to the first guide rail 2323 and the second guide rail 1123.

The support frames 2310 and 1110 are formed of a material having superior rigidity to the main material of the rotation guide 2300 and the housing 1100. For example, the rotation guide 2300 and the housing 1100 may be plastic injection-molded products, and the support frames 2310 and 1110 may be metal.

The support frames 2310 and 1110 may be exposed through the bottom surfaces of the first guide rail 2323 and the second guide rail 1123, and the guide ball 2422 may roll on the support frames 2310 and 1110.

According to an embodiment of the present disclosure, the angle (hereinafter, a first angle) θ formed by two virtual lines passing through the center of the pivot ball 2421 and the center of the two guide balls 2422 may be always 90° or less, preferably, an acute angle.

That is, the first angle θ may satisfy the following conditional expression. In the conditional expression, θₘₐₓ is the maximum first angle. When the condition is satisfied, a load applied to the guide ball 2422 may be reduced, thereby improving driving efficiency.

θₘₐₓ≤90 (unit: deg)

Since the position of the pivot ball 2421 is fixed, the first angle θ may change depending on the positions of the plurality of guide balls 2422. In an example, the plurality of guide balls 2422 may be disposed at any point within the space defined by the first guide rail 2323 and the second guide rail 1123.

As illustrated in FIG. 13, the maximum first angle θₘₐₓ may be defined as the angle formed by two virtual lines passing through the center of the pivot ball 2421 and the center of the two guide balls 2422 which are at the farthest distance from each other.

The rotation guide 2300 may be closely supported in the housing 1100 by a magnetic force (magnetic attraction).

The reflective module 2000 may include a pair of magnetic members that are disposed in the rotation guide 2300 and the housing 1100. The pair of magnetic members may include a pulling magnet 2350 disposed in the rotation guide 2300 and a pulling yoke 1150 disposed in the housing 1100. The pulling yoke 1150 may be inserted into the housing 1100 and provided as an integral part with the housing 1100.

The pulling magnet 2350 and the pulling yoke 1150 may be disposed to face each other, and generate a magnetic attraction in a direction in which they face each other. The pulling magnet 2350 and the pulling yoke 1150 may face in the second-axis direction (the Y-axis direction), and generate the magnetic attraction in the second-axis direction (the Y-axis direction). By the magnetic attraction, the rotation guide 2300 may be closely supported in the housing 1100 in the second-axis direction (the Y-axis direction).

In an example, the direction in which the rotation guide 2300 is supported in the housing 1100 may match a direction in which the rotation guide 2300 and the housing 1100 face each other with the second ball member 2420 interposed therebetween. Therefore, the second ball member 2420 may not escape from the rotation guide 2300 and the housing 1100.

Referring to FIG. 13, the pulling magnet 2350 disposed on the rotation guide 2300 may be disposed within a support region T having a triangular shape approximately defined by the second ball member 2420. Similarly, the pulling yoke 1150 facing the pulling magnet 2350 may also be disposed within the support region T.

While the rotation guide 2300 rotates with respect to the housing 1100, at least a portion of both the pulling magnet 2350 and the pulling yoke 1150 may be continuously disposed within the support region T.

In an example, while the rotation guide 2300 rotates with respect to the housing 1100, the geometric center CP of the pulling magnet 2350 may be continuously disposed within the support region T.

The geometric center CP of the pulling magnet 2350 may approximately coincide with the center of magnetic attraction formed by the pulling magnet 2350 and the pulling yoke 1150. Thus, as the geometric center CP of the pulling magnet 2350 is continuously disposed within the support region T, the rotation guide 2300 may be stably rotated with respect to the housing 1100.

In addition, the geometric center CP of the pulling magnet 2350 may be disposed closer to the pivot ball 2421 than to the plurality of guide balls 2422 within the support region T.

When the rotation guide 2300 rotates relative to the housing 1100, the position of the rotation axis ball 2421 is fixed, while the position of the guide balls 2422 may change, and the shape of the support region T also changes depending on the position of the guide balls 2422.

Accordingly, as the geometric center CP of the pulling magnet 2350 is disposed close to the rotation axis ball 2421 within the support region T, the probability is that the geometric center CP of the pulling magnet 2350 will always be located within the support region T even if the shape of the support region T changes.

The reflective module 2000 may include a second driving unit that provides a driving force to rotate the rotation guide 2300.

The second driving unit may include a second driving magnet 2331 and a second driving coil 2332 arranged to face each other.

The second driving magnet 2331 may be disposed in the rotation guide 2300, and the second driving coil 2332 may be disposed in the housing 1100.

In an example, the second driving magnet 2331 includes two magnets, and two magnets may be disposed on either side surfaces of the rotation guide 2300. The second driving coil 2332 may be disposed on side surfaces of the housing 1100 facing the either side surfaces of the rotation guide 2300, respectively. The second driving magnet 2331 may be in a one-to-one correspondence with the second driving coil 2332. In another embodiment, the positions of the second driving magnet 2331 and the second driving coil 2332 may be interchanged.

The second driving coil 2332 may be mounted on the main substrate 5000, and may be disposed in the housing 1100. The second driving coil 2332 may be exposed to the internal space of the housing 1100 through the through-hole 1103, and thus may directly face the second driving magnet 2331.

In an embodiment, the second driving magnet 2331 and the second driving coil 2332 may face each other in the first-axis direction (the X-axis direction), and generate a driving force in the optical axis direction (the Z-axis direction) in a position spaced apart from the second axis (the Y-axis) (or the pivot ball 2421). By the driving force, the rotation guide 2300 may be rotated about the second axis (the Y-axis).

A surface of the second driving magnet 2331, for example, a surface facing the second driving coil 2332 may include an N-pole and an S-pole. In an example, the surface of the second driving magnet 2331 may include an N-pole (S-pole) region, a neutral region, and an S-pole (N-pole) region in the optical axis direction (the Z-axis direction).

The reflective module 2000 may include a second position sensing unit (or sensor) that detects the position of the rotation guide 2300.

The second position sensing unit may include a second sensing magnet 2335 and a second position sensor 2333 arranged to face each other.

The second sensing magnet 2335 may be disposed in the rotation guide 2300, and the second position sensor 2333 may be disposed in the housing 1100.

In an example, the second sensing magnet 2335 may be disposed on either side surfaces of the rotation guide 2300 together with the second driving magnet 2331. The second sensing magnet 2335 may be spaced apart from the second driving magnet 2331 in the optical axis direction (the Z-axis direction).

A surface of the second sensing magnet 2335 facing the second position sensor 2333 may include an S-pole (N-pole) region, a neutral region, and an N-pole (S-pole) region in the optical axis direction (the Z-axis direction). In an example, the second sensing magnet 2335 and the second driving magnet 2331 may be arranged adjacent to each other in the same polarity region (S-pole and S-pole or N-pole and N-pole).

The second position sensor 2333 may be mounted on the main substrate 5000 together with the second driving coil 2332 and be disposed in the housing 1100.

The second position sensor 2333 may be disposed to face the neutral region of the second sensing magnet 2335.

The second driving magnet 2331 and the second sensing magnet 2335 may be disposed in the rotation guide 2300 and be rotated together with the rotation guide 2300. On the other hand, the second driving coil 2332 and the second position sensor 2333 may be disposed fixedly in the housing 1100.

The second position sensor 2333 may detect a change in magnetic flux to detect the amount of movement of the rotation guide 2300. In an example, the second position sensor 2333 may be provided as a Hall sensor.

The second position sensor 2333 may be spaced apart from the second driving coil 2332 in the optical axis direction (the Z-axis direction). The second position sensor 2333 may be less affected by the magnetic field of the second driving coil 2332, and thus, the sensing accuracy may be improved.

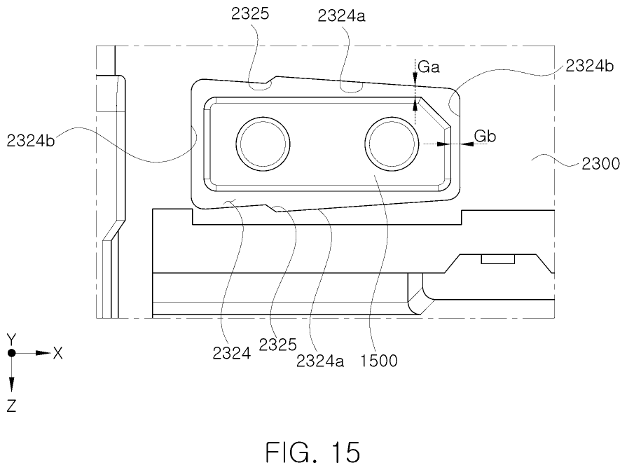

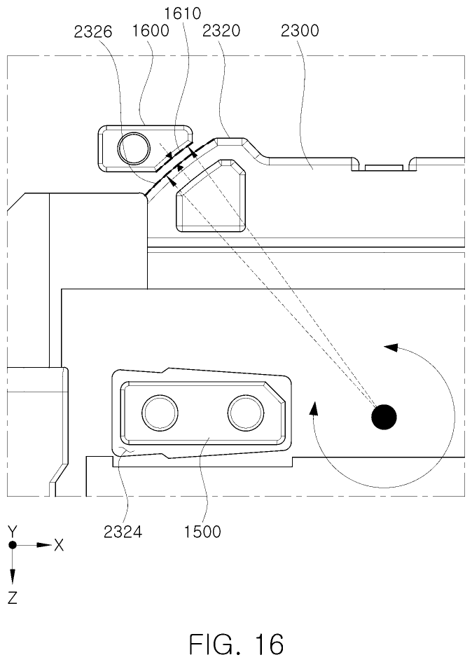

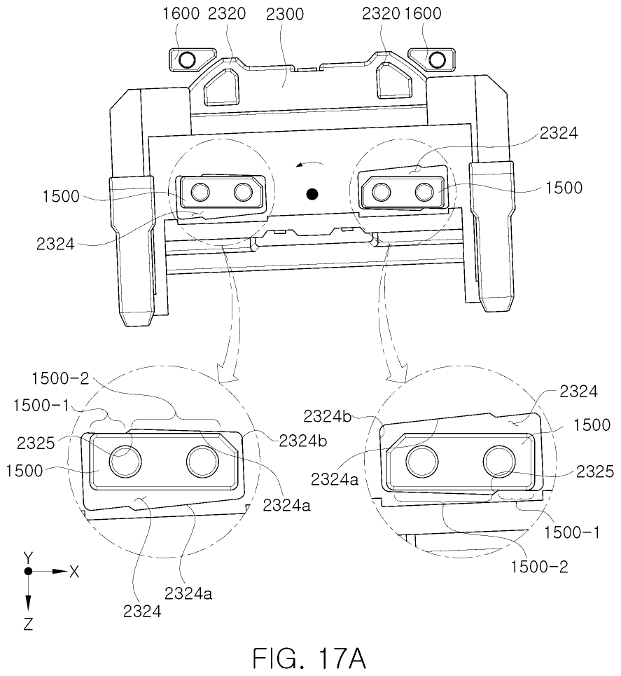

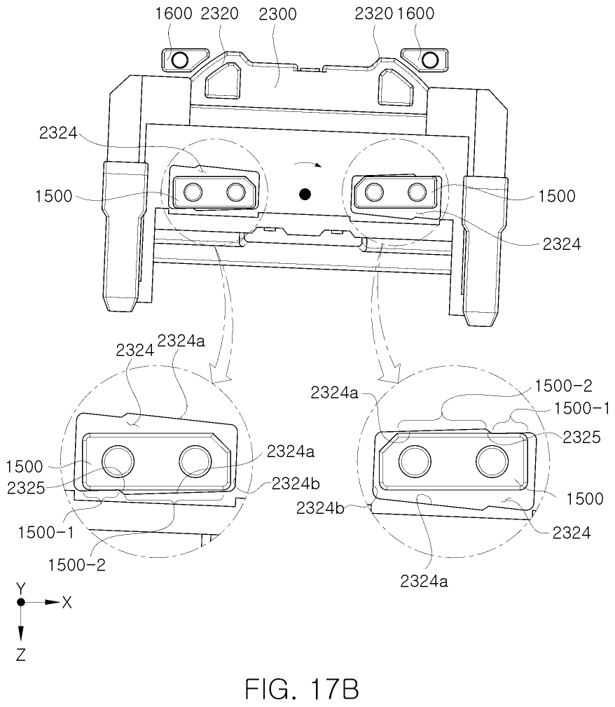

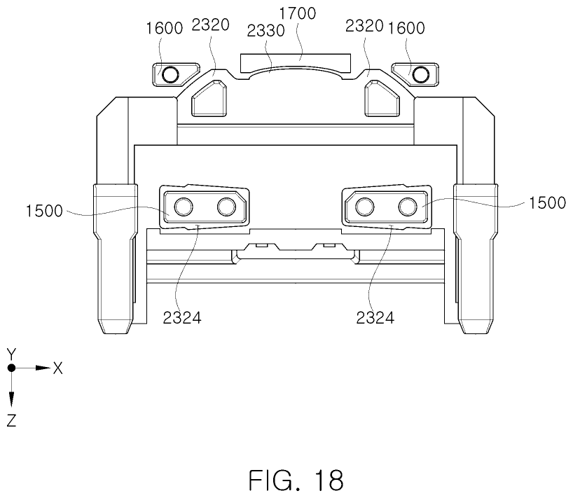

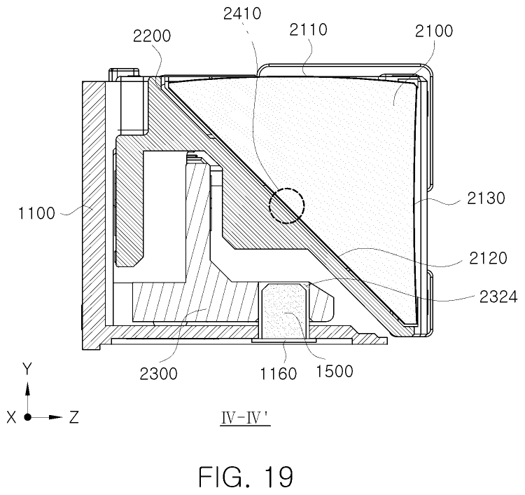

FIG. 15 is an enlarged view of region A (a first damper) of FIG. 14, FIG. 16 is an enlarged view of region B (a second damper) of FIG. 14, FIGS. 17A and 17B are diagrams illustrating a rotational state of the rotation guide, FIG. 18 is a diagram illustrating an additionally arranged auxiliary damper, and FIG. 19 is a cross-sectional view taken along line IV-IV′ of FIG. 9.

According to an embodiment of the present disclosure, the camera module 100 includes dampers 1500 and 1600 for reducing noise occurring in the camera module 100.

The dampers 1500 and 1600 may be formed of a material including an elastic material, such as urethane series, rubber, silicone, sponge, etc. Alternatively, the dampers 1500 and 1600 may be formed of a plastic material, such as the housing 1100.

The dampers 1500 and 1600 may absorb shocks and noise by preventing direct collisions between adjacent structures due to the driving of the reflective module 2000 or external impact. In addition, the dampers 1500 and 1600 may also serve to control the movement of the reflective module 2000 depending on the positions in which the dampers 1500 and 1600 are provided.

The dampers 1500 and 1600 may be formed integrally with the housing 1100. For example, the dampers 1500 and 1600 may be attached to a support frame 1160 inserted into the housing 1100 and provided integrally with the housing 1100. However, the dampers 1500 and 1600 may also be provided in a different form.

Referring to FIG. 14, the dampers 1500 and 1600 include a first damper 1500 and a second damper 1600 arranged in positions spaced apart from each other on the bottom surface of the housing 1100.

The first damper 1500 and the second damper 1600 are formed to protrude from the bottom surface of the housing 1100 toward the internal space of the housing 1100. For example, the first damper 1500 and the second damper 1600 are formed to protrude in the second-axis direction (the Y-axis direction) from the bottom surface of the housing 1100.

The first damper 1500 is disposed to be parallel to the second axis (the Y-axis), which is the rotation axis of the rotation guide 2300. For example, the first damper 1500 is disposed to be parallel to the second axis (the Y-axis) in the first-axis direction (the X-axis direction). The first damper 1500 includes a plurality of dampers, for example, two dampers, and the two dampers are arranged to be spaced apart from each other in the first-axis direction (the X-axis direction) with the pivot ball 2421 forming the second axis (the Y-axis) therebetween.

The rotation guide 2300 includes a damper accommodating portion 2324 accommodating the first damper 1500. A portion of the first damper 1500 is accommodated in the damper accommodating portion 2324.

For example, the damper accommodating portion 2324 may have a hole shape penetrating through the rotation guide 2300 in a thickness direction, for example, in the second-axis direction (the Y-axis direction).

One end of the first damper 1500 may protrude toward the reflective member holder 2200 disposed on the rotation guide 2300 through the hole-shaped damper accommodating portion 2324.

One end of the first damper 1500 is provided to directly face the reflective member holder 2200 in the second-axis direction (the Y-axis direction).

When an impact is applied to the camera module 100 in the second-axis direction (the Y-axis direction), the reflective member holder 2200 first collides with the first damper 1500 (first impact). That is, a direct collision between the reflective member holder 2200 and the rotation guide 2300 or the reflective member holder 2200 and the housing 1100 may be prevented by the first damper 1500, and thus impact and noise may be reduced.

In addition, the first damper 1500 may also function as a stopper controlling the movement of the reflective member holder 2200 when the reflective member holder 2200 rotates about the first axis (the X-axis).

Referring to FIG. 14, the first damper 1500 is accommodated in the damper accommodating portion 2324 at a distance from the damper accommodating portion 2324.

The damper accommodating portion 2324 includes side surfaces defining the damper accommodating portion 2324, and the first damper 1500 is disposed on the inner side of the side surfaces defining the damper accommodating portion 2324 at a distance therefrom.

The side surfaces defining the first damper 1500 and the damper accommodating portion 2324 have a gap in the optical axis direction (the Z-axis direction) and the first-axis direction (the X-axis direction).

The damper accommodating portion 2324 has side surfaces (hereinafter, first side surfaces) 2324a having a length in the first-axis direction (the X-axis direction) and facing the first damper 1500 at a gap in the optical axis direction (the Z-axis direction) and side surfaces (hereinafter, second side surfaces) 2324b having a length in the optical axis direction (the Z-axis direction) and facing the first damper 1500 at a gap in the first-axis direction (the X-axis direction).

There may be a gap in the optical axis direction (the Z-axis direction) from the first side surfaces 2324a of the damper accommodating portion 2324 to the first damper 1500 and a gap in the first-axis direction (the X-axis direction) from the second side surfaces 2324b of the damper accommodating portion 2324 to the first damper 1500.

The gap between the first damper 1500 and the first side surfaces 2324a and the second side surfaces 2324b restricts a linear movement of the rotation guide 2300.

For example, the damper accommodating portion 2324 is formed to have minimum gaps Ga and Gb in the optical axis direction (the Z-axis direction) and the first-axis direction (the X-axis direction) with the first damper 1500 near the center of rotation. Accordingly, the movement of the rotation guide 2300 in the corresponding direction may be reduced.

When the rotation guide 2300 rotates, the gap between the first damper 1500 and the first side surfaces 2324a may vary.

For example, when the rotation guide 2300 rotates about the second axis (the Y-axis), the rotation guide 2300 moves in a circumferential direction of a circle with the second axis (the Y-axis) as the center and a distance from the second axis (the Y-axis), that is, the center of rotation, as the radius. This movement generates displacement in the optical axis direction (the Z-axis direction), and the size of the displacement is proportional to the distance from the center of rotation.

Accordingly, the first side surfaces 2324a may be formed in a form in which the width of the damper accommodating portion 2324 expands approximately away from the second axis (the Y-axis), that is, the center of rotation. For example, the gap between the first side surfaces 2324a increases approximately away from the center of rotation, and the gap between the first side surfaces 2324a and the first damper 1500 also increases approximately away from the center of rotation.

The first side surfaces 2324a are provided with a step portion 2325. The step portion 2325 is formed to narrow the width of the damper accommodating portion 2324. For example, a damper accommodating portion 2324 may expand in width as it extends away from the center of rotation, narrow once at the step portion 2325, and then expand again.

One end of the first damper 1500 in the length direction is disposed to be closest to the center of rotation, and the other end is disposed to be farthest from the center of rotation. The step portion 2325 is provided to face a portion closer to the other end than the one end of the first damper 1500. In other words, the damper accommodating portion 2324 may narrow once in width in a portion in which a moving distance is relatively large due to the step portion 2325.

The first damper 1500 may function as a stopper controlling the movement of the rotation guide 2300 by colliding with the first side surfaces 2324a of the damper accommodating portion 2324 when the rotation guide 2300 rotates.

For example, when the rotation guide 2300 rotates about the second axis (the Y-axis), the first damper 1500 first collides with the first side surfaces 2324a in the step portion 2325, and then a portion (outer portion) 1500-1 having a larger movement distance than the portion colliding with the step portion 2325 collides with the first side surfaces 2324a.

When the rotation guide 2300 rotates about the second axis (the Y-axis), the first damper 1500 disposed on one side with respect to the second axis (the Y-axis) and the first damper 1500 disposed on the opposite side have opposite movement directions, so they collide with the first side surfaces 2324a in opposite directions, respectively.

For example, referring to FIG. 17A, when the rotation guide 2300 rotates clockwise with respect to the second axis (the Y-axis), the first damper 1500 disposed on one side with respect to the second axis (the Y-axis) collides with the first side surface 2324a facing in a −Z direction and the first damper 1500 disposed on the opposite side collides with the first side surface 2324a facing in a +Z direction. Similarly, as illustrated in FIG. 17B, when the rotation guide 2300 rotates counterclockwise with respect to the second axis (the Y-axis), the first damper 1500 disposed on one side with respect to the second axis (the Y-axis) collides with the first side surface 2324a facing in the +Z direction and the first damper 1500 disposed on the opposite side collides with the first side surface 2324a facing in the −Z direction.

Meanwhile, a portion (an inner portion) 1500-2 having a shorter moving distance than the portion colliding with the step portion 2325 of the first damper 1500 may be spaced apart by a gap from the first side surfaces 2324a in the maximum rotation state of the rotation guide 2300.

The second damper 1600 is disposed to be spaced apart from the first damper 1500 in the optical axis direction (the Z-axis direction) on the bottom surface of the housing 1100.

The second damper 1600 includes a plurality of dampers, for example, two or more dampers, and the two dampers are spaced apart from each other in the first-axis direction (the X-axis direction).

The second damper 1600 is disposed so as not to overlap the rotation guide 2300. The second damper 1600 is disposed in a position spaced apart in the radial direction of the second axis (the Y-axis) and a circle with the second axis (the Y-axis) as the center of rotation.

Referring to FIG. 14, the rotation guide 2300 includes a protrusion 2320 protruding from the rear of the reflective member 2100 toward the housing 1100. The protrusion 2320 is spaced apart in the first-axis direction (the X-axis direction) on the rotation guide 2300. The second damper 1600 is spaced apart in the first-axis direction (the X-axis direction) with the protrusion 2320 in between.

Referring to FIG. 16, the second damper 1600 is spaced apart from the protrusion 2320 and the second damper 1600 the protrusion 2320 are disposed to face each other. The second damper 1600 and the protrusion 2320 are provided to face each other in the radial direction of a circle with the second axis (the Y-axis) as the center of rotation.

The opposing surfaces of the second damper 1600 and the protrusion 2320 may be curved.

For example, the opposing surfaces 1610 and 2326 of the second damper 1600 and the protrusion 2320 may be surfaces including a portion of a circle with the second axis (the Y-axis) as the center of rotation and a distance from the center of rotation to them as the radius.

In addition, the area of one surface 2326 of the protrusion 2320 facing the second damper 1600 is provided to be wider than the area of one surface 1610 of the second damper 1600 facing the protrusion 2320.

The second damper 1600 and the protrusion 2320 do not come into contact with each other when the rotation guide 2300 rotates. Instead, the second damper 1600 and the protrusion 2320 may come into contact with each other when the rotation guide 2300 moves in a direction other than the rotation direction, for example, in the optical axis direction (the Z-axis direction) and/or the first-axis direction (the X-axis direction).

In detail, since the second damper 1600 and the protrusion 2320 face each other in a direction approximately diagonal to the optical axis direction (the Z-axis direction) and the first-axis direction (the X-axis direction), the gap between the second damper 1600 and the protrusion 2320 in the optical axis direction (the Z-axis direction) and the first-axis direction (the X-axis direction) may be minimized. That is, the second damper 1600 may restrict the linear movement of the rotation guide 2300 together with the first damper 1500.

In an embodiment, the camera module 100 may further include an auxiliary damper 1700.

The auxiliary damper 1700 is formed to protrude from the bottom surface of the housing 1100 in the second-axis direction (the Y-axis direction).

The auxiliary damper 1700 is disposed between the second dampers 1600 spaced apart in the first-axis direction (the X-axis direction).

Referring to FIG. 18, the auxiliary damper 1700 may be provided as one damper having a length in the first-axis direction (the X-axis direction). However, the auxiliary damper 1700 may be divided into multiple parts and provided.

The rotation guide 2300 may additionally include a protrusion 2330 in a position corresponding to the auxiliary damper 1700.

For example, the rotation guide 2300 may include a first protrusion 2320 facing the second damper 1600 and a second protrusion 2330 facing the auxiliary damper 1700.

The auxiliary damper 1700 and the second protrusion 2330 are arranged to face each other with a gap in the radial direction of a circle with the second axis (Y axis) as the center of rotation.

The opposing surfaces of the auxiliary damper 1700 and the second protrusion 2330 may be curved, and the area of one surface of the second protrusion 2330 facing the auxiliary damper 1700 may be provided to be wider than the area of one surface of the auxiliary damper 1700 facing the second protrusion 2330.

The auxiliary damper 1700 restricts movement of the rotation guide 2300 other than in the rotational direction. For example, the auxiliary damper 1700 may not come into contact with the second protrusion 2330 when the rotation guide 2300 rotates but may come into contact with the second protrusion 2330 when the rotation guide 2300 moves in a straight direction.

In addition, the description regarding the second damper 1600 may be equally applied to the auxiliary damper 1700.

The reflective module 2000 may include an auxiliary member 2500 having a similar function to the aforementioned dampers 1500 and 1600.

The auxiliary member 2500 may be coupled to the rotation guide 2300 to surround a portion of the reflective member holder 2200. In an example, the auxiliary member 2500 may be disposed to surround a portion of the reflective member holder 2200 which is supported on the rotation guide 2300 with the first ball member 2410 interposed therebetween.

In addition, the auxiliary member 2500 may be spaced apart from the reflective member holder 2200 by a gap in a state of being coupled to the rotation guide 2300 so as not to interfere with the rotation of the reflective member holder 2200.

The upper and lower edges of the auxiliary member 2500 are provided with elastic material members. The elastic material members are provided to wrap around the auxiliary member 2500.

When the reflective member holder 2200 rotates about the first axis (the X-axis), the elastic member covering the upper and lower edges of the auxiliary member 2500 may collide with housing 1100 and the case 1300.

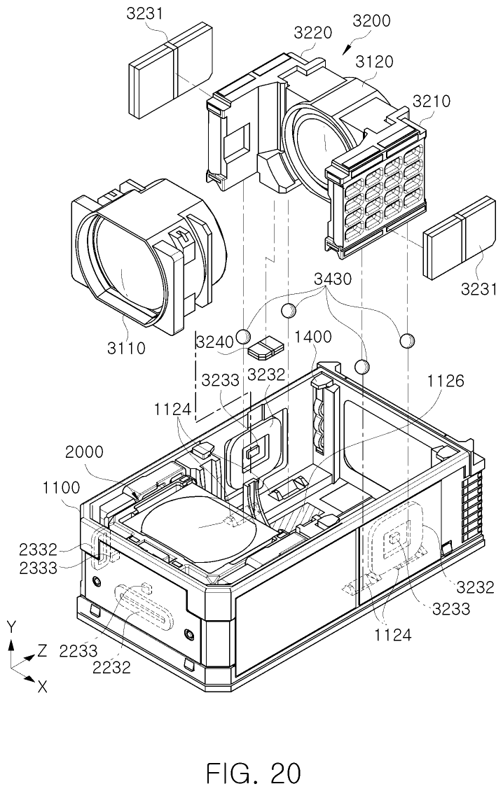

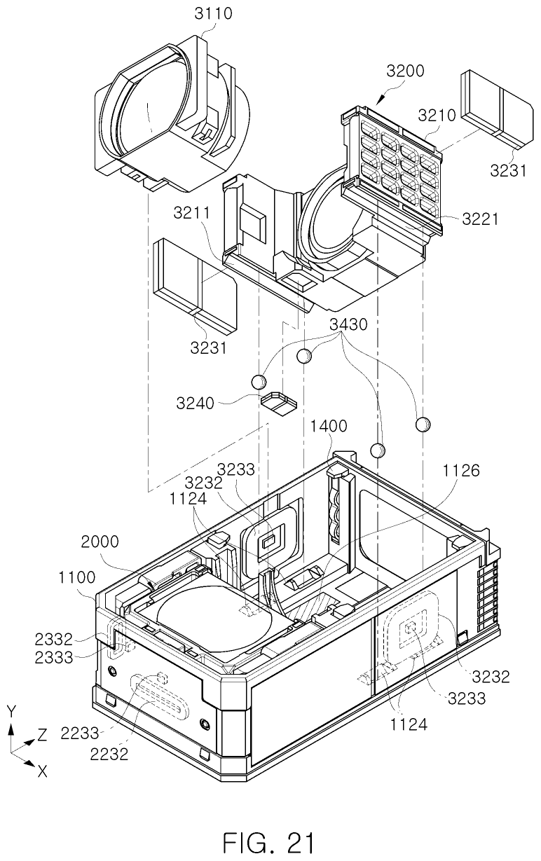

FIG. 20 is an exploded perspective view of a lens module according to an embodiment of the present disclosure, and FIG. 21 is a bottom exploded perspective view of a lens module according to an embodiment of the present disclosure.

The lens module 3000 may include a plurality of lens barrels. The plurality of lens barrels may each include at least one lens arranged in the optical axis direction (the Z-axis direction), respectively.

In an embodiment, the plurality of lens barrels may include a first lens barrel 3110 and a second lens barrel 3120. The first lens barrel 3110 may be disposed on an object side of the second lens barrel 3120. In an example, light reflected from the reflective module 2000 may be incident on the image sensor 4100 after passing through the first lens barrel 3110 and the second lens barrel 3120 in sequence.

The first lens barrel 3110 may be fixedly disposed in the housing 1100, and the second lens barrel 3120 may be disposed to be relatively movable with respect to the housing 1100.

The lens module 3000 may include a lens holder 3200 to which the second lens barrel 3120 is coupled. The second lens barrel 3120 may be moved in the optical axis direction (the Z-axis direction) together with the lens holder 3200.

As the second lens barrel 3120 moves in the optical axis direction (the Z-axis direction), the gap between the second lens barrel 3120, the first lens barrel 3110, and the image sensor 4100 in the optical axis direction (the Z-axis direction) changes, thereby enabling the autofocus adjustment function and zoom function of the camera module 100.

The lens holder 3200 may include a first side wall 3210 and a second side wall 3220 disposed opposite to each other with respect to the optical axis (the Z-axis). The second lens barrel 3120 may be disposed between the first side wall 3210 and the second side wall 3220.

The first side wall 3210 may extend in the optical axis direction (the Z-axis direction) from one side of the second lens barrel 3120, and the second side wall 3220 may extend in the optical axis direction (the Z-axis direction), parallel to the first side wall 3210, from the other side of the second lens barrel 3120. In an example, ends of the first side wall 3210 and the second side wall 3220 may be disposed between the housing 1100 and the first lens barrel 3110, and the first lens barrel 3110 may be disposed between the first side wall 3210 and the second side wall 3220.

A third ball member 3430 may be disposed between the lens holder 3200 and the housing 1100 to support movement of the lens holder 3200.

The third ball member 3430 may include three or more balls. In an example, the third ball member 3430 may include four balls.

In an embodiment, four balls may support one side and the other side of the lens holder 3200, respectively. In an example, two balls among the four balls may be disposed between the first side wall 3210 of the lens holder 3200 and the housing 1100, and the remaining two balls may be disposed between the second side wall 3220 of the lens holder 3200 and the housing 1100.

The first side wall 3210 and the second side wall 3220 of the lens holder 3200 and one surface of the housing 1100 may be provided with guide recesses accommodating the third ball member 3430.

A third guide recess 3211 and 3221 having a length in the optical axis direction (the Z-axis direction) may be provided on a bottom surface of the first side wall 3210 and the second side wall 3220 of the lens holder 3200. In addition, a fourth guide recess 1124 having a length in the optical axis direction (the Z-axis direction) may be provided on a bottom surface of the housing 1100 in a position facing the third guide recess 3211 and 3221.

For example, one third guide groove 3211 and one third guide groove 3221 are provided in the first side wall 3210 and the second side wall 3220, respectively, and the third guide groove 3211 provided in the first side wall 3210 and the third guide groove 3221 provided in the second side wall 3220 of the lens holder 3200 may face two fourth guide grooves 1124, respectively. The two fourth guide grooves 1124 facing the third guide grooves 3211 and 3221 provided in the first side wall 3210 or the second side wall 3220 of the lens holder 3200 are provided to be spaced apart from each other in the optical axis direction (the Z-axis direction) and may have a shorter length in the optical axis direction (the Z-axis direction) than the third guide grooves 3211 and 3221.

Two balls are accommodated in each of the third guide groove 3211 provided on the first side wall 3210 and the third guide groove 3221 provided on the second side wall 3220, and a ball may be accommodated individually in the fourth guide groove 1124.

The third ball member 3430 is inserted between the third guide grooves 3211 and 3221 and the fourth guide groove 1124 and rolls in the optical axis direction (the Z-axis direction) to support movement of the lens holder 3200 in the optical axis direction (the Z-axis direction).

The third guide groove 3211 provided on the first side wall 3210 and the third guide groove 3221 provided on the second side wall 3220 of the lens holder 3200 may have different cross-sectional shapes.

A ball disposed between the third guide groove 3211 provided on the first side wall 3210 of the lens holder 3200 and the fourth guide groove 1124 facing the third guide groove 3211 makes two-point contact with each of the third guide groove 3211 and the fourth guide groove 1124. Meanwhile, a ball disposed between the third guide groove 3221 provided on the second side wall 3220 of the lens holder 3200 and the fourth guide groove 1124 facing the third guide groove 3221 makes one-point contact with the third guide groove 3221 and two-point contact with the fourth guide groove 1124.

The ball disposed between the first side wall 3210 of the lens holder 3200 and the housing 1100 functions as a main guide, and the ball disposed between the second side wall 3220 of the lens holder 3200 and the housing 1100 functions as an auxiliary guide.

The lens holder 3200 may be closely supported by the housing 1100 by magnetic force (magnetic attraction).

The lens module 3000 may include a pair of magnetic members that are disposed in the lens holder 3200 and the housing 1100. The pair of magnetic members may include a pulling magnet 3240 disposed in the lens holder 3200 and a pulling yoke 1126 disposed in the housing 1100.

The pulling magnet 3240 and the pulling yoke 1126 may be disposed to face each other, and generate a magnetic attraction in a direction in which they face each other. The pulling magnet 3240 and the pulling yoke 1126 may face each other in the second-axis direction (the Y-axis direction), and generate the magnetic attraction in the second-axis direction (the Y-axis direction). By the magnetic attraction, the lens holder 3200 may be closely supported in the housing 1100 in the second-axis direction (the Y-axis direction).

The direction in which the lens holder 3200 is supported by the housing 1100 may match the direction in which the lens holder 3200 and the housing 1100 face each other with the third ball member 3430 interposed therebetween. Therefore, by the magnetic attraction, the third ball member 3430 may not escape from between the lens holder 3200 and the housing 1100.

The pair of magnetic members may be arranged to be inclined toward the main guide. For example, the pair of magnetic members are disposed between the optical axis (the Z-axis) and the first side wall 3210. Therefore, attractive force generated by the pair of magnets acts more strongly on the main guide than on the auxiliary guide.

The lens module 3000 may include a third driving unit that provides a driving force to move the lens holder 3200.

The third driving unit may include a third driving magnet 3231 and a third driving coil 3232 arranged to face each other.

The third driving magnet 3231 may be disposed in the lens holder 3200, and the third driving coil 3232 may be disposed in the housing 1100.

In an example, the third driving magnet 3231 may be disposed on at least one of the first side wall 3210 and the second side wall 3220 of the lens holder 3200, and the third driving coil 3232 may be disposed on a side surface of the housing 1100 facing the at least one of the first side wall 3210 and the second side wall 3220. The third driving magnet 3231 may be in a one-to-one correspondence with the third driving coil 3232.

The third driving coil 3232 may be mounted on the main substrate 5000, and may be disposed in the housing 1100. The third driving coil 3232 may be exposed to the internal space of the housing 1100 through the through-hole 1105, and thus may directly face the third driving magnet 3231.

In an embodiment, the third driving magnet 3231 and the third driving coil 3232 may face each other in the first-axis direction (the X-axis direction), and generate a driving force in the optical axis direction (the Z-axis direction). By the driving force, the lens holder 3200 and the like may move in the optical axis direction (the Z-axis direction).

A surface of the third driving magnet 3231, for example, a surface facing the third driving coil 3232 may include an N-pole and an S-pole. In an example, the surface of the third driving magnet 3231 may include an N-pole (S-pole) region, a neutral region, and an S-pole (N-pole) region in the optical axis direction (the Z-axis direction).

The lens module 3000 may include a third position sensor 3233 that detects the position of the lens holder 3200.

The third position sensor 3233 may be mounted on the main substrate 5000 together with the third driving coil 3232, and disposed in the housing 1100.

The third position sensor 3233 may face the third driving magnet 3231 through the through-hole 1105. In an example, the third position sensor 3233 may be disposed to face the neutral region of the third driving magnet 3231.

The third position sensor 3233 may detect a change in magnetic flux to detect the amount of movement of the lens holder 3200. In an example, the third position sensor 3233 may be provided as a Hall sensor.

A stopper 1400 may be disposed to face the lens module 3000 in the optical axis direction (the Z-axis direction) in the housing 1100. For example, stoppers 1400 may be provided to be fitted into the wall of the housing 1100.

The stopper 1400 may include a deformable elastic member. The elastic member may protrude toward the lens module 3000. For example, the elastic member may face the first side wall 3210 and the second side wall 3220 of the lens holder 3200 in the optical axis direction (the Z-axis direction), respectively.

The lens holder 3200 may first come into contact with the elastic member by movement in the optical axis direction (the Z-axis direction).

The elastic member may prevent direct collision between the lens module 3000 and the housing 1100 and absorb the impact and noise resulting from the collision. In addition, the elastic member may constrain the movement amount of the lens holder 3200.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflective module comprising:
a housing having an internal space;
a rotation guide disposed in the internal space and configured to rotate about a first axis, relative to the housing;
a reflective member holder comprising a reflective member and supported by the rotation guide; and
a damper protruding from a bottom surface of the housing toward the internal space,
wherein the damper comprises:
a first damper disposed adjacently to the first axis; and
a second damper disposed in a position spaced apart from the first damper.

2. The reflective module of claim 1, further comprising:
a pivot ball disposed between the housing and the rotation guide, through which the first axis passes; and
a plurality of guide balls disposed in a position spaced apart from the pivot ball between the housing and the rotation guide,
wherein a distance between the pivot ball and the first damper is shorter than a distance between the pivot ball and the plurality of guide balls, and a distance between the pivot ball and the second damper is greater than the distance between the pivot ball and the plurality of guide balls.

3. The reflective module of claim 2, wherein
the rotation guide comprises a damper accommodating portion penetrating through the rotation guide in a direction parallel to the first axis, and
the first damper is disposed in the damper accommodating portion.

4. The reflective module of claim 3, wherein the damper accommodating portion has a width increasing away from the first axis at least in a portion.

5. The reflective module of claim 4, wherein the damper accommodating portion comprises:
a first side surface facing the first damper in a first direction; and
a second side surface facing the first damper in a second direction perpendicular to the first direction,
wherein the first direction and the second direction are directions perpendicular to the first axis.

6. The reflective module of claim 5, wherein the first side surface comprises a step portion formed to protrude toward the first damper, and
wherein the damper accommodating portion comprises a width that is narrowed once in the step portion.

7. The reflective module of claim 6, wherein, when the rotation guide rotates based on the first axis, the first damper contacts the first side surface on the outside of the step portion in a radial direction of a circle centered on the first axis.

8. The reflective module of claim 3, wherein the first damper faces the reflective member holder in the first-axis direction.

9. The reflective module of claim 2, wherein the rotation guide protrudes toward the housing and comprises a first protrusion facing the second damper in a radial direction of a circle centered on the first axis.

10. The reflective module of claim 9, wherein opposing surfaces of the second damper and the first protrusion are curved.

11. The reflective module of claim 10, wherein the opposing surfaces of the second damper and the first protrusion each include a portion of a circle having an arbitrary radius centered on the first axis.

12. The reflective module of claim 2, wherein the first damper and the second damper each comprise a plurality of dampers spaced apart from each other in a direction perpendicular to the first axis.

13. The reflective module of claim 12, further comprising an auxiliary damper disposed between the second dampers and facing the rotation guide,
wherein the rotation guide comprises a second protrusion facing the auxiliary damper in a radial direction of a circle centered on the first axis.

14. The reflective module of claim 13, wherein opposing surfaces of the auxiliary damper and the second protrusion are curved.

15. A camera module comprising:
a reflective module according to claim 1; and
a lens module comprising a plurality of lenses disposed in an optical axis direction and configured to be movable in the optical axis direction.

16. The camera module of claim 15, wherein the reflective module is configured to be rotatable about the first axis and a second axis perpendicular to the first axis, and
wherein both the first axis and the second axis are perpendicular to the optical axis direction.
